(19) United States
(12) Patent Application Publication
(10) Pub. No.: US 2023/0131312 A1
(43) Pub. Date: Apr. 27, 2023

(54) SYNTHESIS METHOD OF POLYETHER FOR LOW-MODULUS SEALANT

(71) Applicants: Zhejiang Huangma Technology Co., Ltd., Shaoxing, Zhejiang (CN); Zhejiang Huangma Shangyi New Material Co., Ltd., Shaoxing, Zhejiang (CN); Zhejiang Lukean Chemical Co., Ltd., Shaoxing, Zhejiang (CN); Shangyu Huangma Surface Activated Reagent Research Institute Co., Ltd., Shaoxing, Zhejiang (CN)

(72) Inventors: Weisong Wang, Shaoxing, Zhejiang (CN); Yifeng Jin, Shaoxing, Zhejiang (CN); Ran Kou, Shaoxing, Zhejiang (CN); Majishi Wang, Shaoxing, Zhejiang (CN); Xingjun Zhao, Shaoxing, Zhejiang (CN)

(21) Appl. No.: 17/782,670

(22) PCT Filed: Jun. 29, 2020
(86) PCT No.: PCT/CN2020/098800

§ 371 Date: Jun. 6, 2022

(30) Foreign Application Priority Data
Dec. 6, 2019 (CN) 201911243263.4

(51) Int. Cl. C08G 65/26; C09K 3/10

(52) U.S. Cl. CPC C08G 65/2696; C09K 3/10; C08G 65/2663; C08G 65/2609; C09K 2200/0662

(57) ABSTRACT

The present disclosure discloses a synthesis method of polyether for a low-modulus sealant, belonging to the technical field of organic compound synthesis. In the synthesis method of the present disclosure, a reaction is performed by using a mixture of monohydric alcohol polyoxypropylene ether and polyhydric alcohol polyoxypropylene ether as a starter, using epoxypropane as a chain extender and adding a metal complex catalyst, so as to obtain the polyether for the low-modulus sealant after the reaction is ended. The polyether prepared in the present disclosure can not only well enhance the rigid strength of the sealant but also reduce the elasticity modulus of the sealant, overcoming the problem that the existing polyether silane modified sealant is high in modulus. The synthesis method of the present disclosure is simple in synthesis process, easy to produce and control, short in production period and low in energy consumption.

### TECHNICAL FIELD

The present disclosure relates to the technical field of organic compound synthesis, and particularly to a synthesis method of polyether for a low-modulus sealant.

### BACKGROUND

As more and more attentions are paid to energy consumption and environmental protection in China, prefabricated buildings gradually become one of main directions for building development in the future due to short construction period, low energy consumption, little pollution, safe construction and the like. Particularly, for the prefabricated buildings, compared with traditional concrete buildings, on-site refuses are reduced by about 80%, material loss is decreased by nearly 60%, the number of builders is dropped by about 90% and a building period is shortened by about 70%. However, during the assembling, there are lots of joints especially joints of an exterior wall in the prefabricated buildings to undergo waterproof sealing treatment. Thus, a sealant is the first defensive line for waterproof sealing, and its performance directly affects the effect of waterproof sealing.

The prefabricated buildings have relatively high requirements on the sealant in the aspects of displacement resistance, elastic recovery rate and weather resistance, and therefore it is urgent to develop a low-modulus sealant to meet market's demands. At present, low-modulus sealants used in a building material market mainly include a polyurethane (PU) building sealant, a silane modified polyether (MS) building sealant and a silicone (SR) building sealant. The PU building sealant has a low price, a good adhesion property and an excellent deformation adapting ability, but its structure contains lots of carbamate bonds, so it has serious defects in the aspects of ultraviolet resistance and the like. Although the SR building sealant has excellent exhibitions in the aspects of acid-alkaline resistance and weather resistance, but its application scope is limited by its non-paintability. The silane modified polyether sealant is a building sealing material that is fastest developed in recent 30 years, which simultaneously has good adhesion property of PU as well as excellent acid-alkaline resistance and weather resistance of the silicone sealant, is environmental-friendly and odorless and does not pollute a base material. The silane modified polyether sealant has a paintable surface, and is the most suitable building sealing material for industrialized buildings, however, currently, the silane modified polyether sealant (such as glycerol polyether silicone oil/propylene glycol polyether modified sealants) modified by completely using polyhydric alcohol polyoxypropylene ether silane is high in modulus, which leads to insufficient elasticity, so as to affect its use effect.

Thus, it is extremely necessary to develop a synthesis method of polyether for a low-modulus sealant.

### SUMMARY

In order to overcome the shortcomings of the prior art, the objective of the present disclosure is to provide a synthetic method of polyether for a low-modulus sealant. The polyether prepared in the present disclosure can not only well enhance the rigid strength of the sealant, but also reduce the elasticity modulus of the sealant, overcoming the problem that the existing polyether silane modified sealant is high in modulus.

To solve the above problem, the technical solution adopted by the present disclosure is as follows:

Provided is a synthesis method of polyether for a low-modulus sealant, comprising the following steps: reacting by using a mixture of monohydric alcohol polyoxypropylene ether and polyhydric alcohol polyoxypropylene ether as a starter, using epoxypropane as a chain extender and adding a metal complex catalyst, so as to obtain the polyether for the low-modulus sealant after the reaction is ended. A specific reaction formula is as follows:

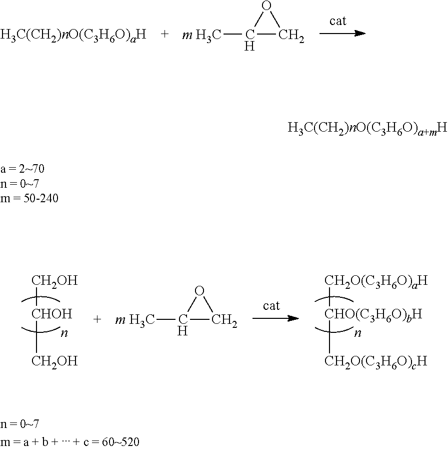

As a preferred embodiment of the present disclosure, in the starter, a weight ratio of the monohydric alcohol polyoxypropylene ether to the polyhydric alcohol polyoxypropylene is (5:95)-(30:70).

As a preferred embodiment of the present disclosure, the monohydric alcohol polyoxypropylene ether is a mixture of any one or more than two of butanol polyoxypropylene ether, ethanol polyoxypropylene ether, propanol polyoxypropylene ether, C6 alcohol polyoxypropylene ether, C8 alcohol polyoxypropylene ether, C10 alcohol polyoxypropylene ether and C12 alcohol polyoxypropylene ether.

As a preferred embodiment of the present disclosure, the polyhydric alcohol polyoxypropylene is a mixture of any one or more than two of glycerol polyoxypropylene ether, ethylene glycol polyoxypropylene ether, propylene glycol polyoxypropylene ether, pentaerythritol polyoxypropylene ether, sorbitol polyoxypropylene ether and sucrose alcohol polyoxypropylene ether.

As a preferred embodiment of the present disclosure, the molecular weights of the monohydric alcohol polyoxypropylene ether and the polyhydric alcohol polyoxypropylene are both 300-4000.

As a preferred embodiment of the present disclosure, the molecular weight of the polyether for the low-modulus sealant is 4000-30000.

As a preferred embodiment of the present disclosure, the amount of the catalyst is 10-100 ppm of a total amount of the starter and the epoxypropane.

As a preferred embodiment of the present disclosure, the catalyst is a dimetallic complex DMC catalyst or a multi-metallic MM complex catalyst, or a mixture thereof.

As a preferred embodiment of the present disclosure, the amount of the epoxypropane is 4-15 times the weight of the starter.

As a preferred embodiment of the present disclosure, a reaction temperature is 100-180° C.

Compared with the prior art, the present disclosure has the beneficial effects:

(1) according to the synthesis method of the polyether for the low modulus sealant described herein, the polyether is synthesized by using the mixture of the monohydric alcohol polyoxypropylene ether and the polyhydric alcohol polyoxypropylene ether as the starter and using the epoxypropane as the chain extender, so that on the one hand, the hydroxyl polyhydric alcohol polyoxypropylene ether is cross-linked with water after being modified by silane end capping to form a grid-shaped structure so as to effectively ensure the strength of solidification, and on the other hand, one end of the monohydric alcohol polyoxypropylene ether containing a hydroxyl group participates in a cross-linking reaction and linked to the grid-shaped structure, and the other end is remained as an inert group so as to effectively increase the entire stretching elasticity, consequently, the sealant prepared from the polyether of the present disclosure has not only rigid strength but also reduced elasticity modulus, and has good tensile property.

(2) The synthesis method of the present disclosure is simple in process, less in steps, short in production period, low in energy consumption, and easy to produce and control.

### DETAILED DESCRIPTION OF THE EMBODIMENTS

A synthesis method of polyether for a low-modulus sealant comprises the following steps: adding a mixture of monohydric alcohol polyoxypropylene ether and polyhydric alcohol polyoxypropylene ether and a metal complex catalyst in a reactor, vacuuming, replacing air in the reactor with N₂, performing heating dehydration while vacuuming when a vacuum degree is ≥−0.096 Mpa, and performing preservation and dehydrating for 0.5-2 h when heating to 120-130° C.; adding epoxypropane for reaction, wherein a reaction temperature is 100-180° C., a pressure in the reactor is −0.05 to 0.40 Mpa, performing preservation and continuing to react until the pressure drops no longer; and after the reaction is ended, degassing in vacuum, maintaining a vacuum degree for 10-30 min when it is ≥−0.098 Mpa, and cooling to obtain the polyether for the low-modulus sealant, which has a molecular weight of 4000-30000.

A specific reaction formula is as follows:

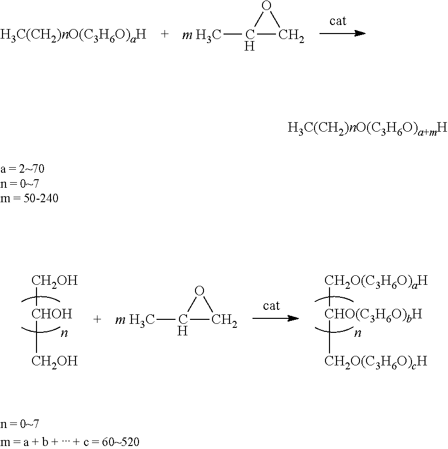

In the above method, the weight ratio of the monohydric alcohol polyoxypropylene ether to the polyhydric alcohol polyoxypropylene is (5:95)-(30:70). The amount of epoxypropane is 4-15 times the weight of the starter. The amount of the catalyst is 10-100 ppm of the total weight of the starter and the epoxypropane

Preferably, the monohydric alcohol polyoxypropylene ether is a mixture of any one or more than two of butanol polyoxypropylene ether, ethanol polyoxypropylene ether, propanol polyoxypropylene ether, C6 alcohol polyoxypropylene ether, C8 alcohol polyoxypropylene ether, C10 alcohol polyoxypropylene ether and C12 alcohol polyoxypropylene ether. The polyhydric alcohol polyoxypropylene is a mixture of any one or more than two of glycerol polyoxypropylene ether, ethylene glycol polyoxypropylene ether, propylene glycol polyoxypropylene ether, pentaerythritol polyoxypropylene ether, sorbitol polyoxypropylene ether and sucrose alcohol polyoxypropylene ether. The molecular weights of the monohydric alcohol polyoxypropylene ether and the polyhydric alcohol polyoxypropylene are both 300-4000. The catalyst is a dimetallic complex DMC catalyst or a multi-metallic complex MMC catalyst, or a mixture thereof.

Next, the present disclosure will be further described in detail in combination with specific embodiments. In the following examples, a high-pressure stirring reactor is repeatedly washed with distilled water prior to reaction until it is clean, and the reactor is dried and cooled to room temperature for future use. Components used in the following examples, unless otherwise indicated, are all commercially available.

### Example 1

92 g of propylene glycol polyoxypropylene ether with a molecular weight of 400, 8 g of butanol polyoxypropylene ether with a molecular weight of 300 and 0.026 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, preservation and dehydration was performed for 1 h after the temperature was 120° C. After dehydration was ended, 1175 g of epoxypropane was added, wherein the reaction temperature was controlled to 110-130° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product for a low-modulus sealant was obtained by cooling and discharging after the vacuum degree reached ≥−0.098 MPa and was maintained for 10 min.

Product indexes: the molecular weight measured by gel chromatography is 4980, and a hydroxyl value of a sample tested by a chemical method is 21.6 (tested based on GB/T 7383-2007 method, similarly hereinafter).

### Comparative Example 1

100 g of propylene glycol polyoxypropylene ether with a molecular weight of 400 and 0.026 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, preservation and dehydration was performed for 1 h after the temperature was 120° C. After dehydration was ended, 1148 g of epoxypropane was added, wherein the reaction temperature was controlled to 110-130° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product was obtained by cooling and discharging after the vacuum degree reached ≥−0.098 MPa and was maintained for 10 min.

Product indexes: the molecular weight measured by gel chromatography is 4982, and a hydroxyl value of a sample tested by a chemical method is 22.5.

### Example 2

115 g of glycerol polyoxypropylene ether with a molecular weight of 800, 20 g of ethanol polyoxypropylene ether with a molecular weight of 1200 and 0.060 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, preservation and dehydration was performed for 1 h after the temperature was 120° C. After dehydration was ended, 1230 g of epoxypropane was added, wherein the reaction temperature was controlled to 120-150° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product for a low-modulus sealant was obtained by cooling and discharging after the vacuum degree reached ≥−0.098 MPa and was maintained for 10 min.

Product indexes: the molecular weight measured by gel chromatography is 8610, and a hydroxyl value of a sample tested by a chemical method is 18.6.

### Comparative Example 2

100 g of glycerol polyoxypropylene ether with a molecular weight of 800 and 0.060 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, preservation and dehydration was performed for 1 h after the temperature was 120° C. After dehydration was ended, 986 g of epoxypropane was added, wherein the reaction temperature was controlled to 120-150° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product for a low-modulus sealant was obtained by cooling and discharging after the vacuum degree reached ≥−0.098 MPa and was maintained for 10 min.

Product indexes: the molecular weight measured by gel chromatography is 8588, and a hydroxyl value of a sample tested by a chemical method is 19.6.

### Example 3

108 g of pentaerythritol polyoxypropylene ether with a molecular weight of 1500, 27 g of linear chain C8 alcohol polyoxypropylene ether with a molecular weight of 3000 and 0.1 g of a mixture of dimetallic complex DMC catalyst and multi-metallic complex catalyst MMC were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, the reaction was subjected to preservation and dehydration for 1.5 h after the temperature was 130° C. After dehydration was ended, 1250 g of epoxypropane was added, wherein the reaction temperature was controlled to 130-160° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product for a low-modulus sealant was obtained by cooling and discharging after the vacuum degree reached ≥−0.098 MPa and was maintained for 20 min.

Product indexes: the molecular weight measured by gel chromatography is 18200, and a hydroxyl value of a sample tested by a chemical method is 12.1.

### Comparative Example 3

100 g of pentaerythritol polyoxypropylene ether with a molecular weight of 1500 and 0.1 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, the reaction was subjected to preservation and dehydration for 1.5 h after the temperature was 130° C. After dehydration was ended, 1160 g of epoxypropane was added, wherein the reaction temperature was controlled to 130-160° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product was obtained by cooling and discharging after the vacuum degree reached ≥−0.098 MPa and was maintained for 20 min.

Product indexes: the molecular weight measured by gel chromatography is 18250, and a hydroxyl value of a sample tested by a chemical method is 12.3.

### Example 4

100 g of sorbitol polyoxypropylene ether with a molecular weight of 2500, 35 g of linear chain C10 alcohol polyoxypropylene ether with a molecular weight of 4000 and 0.13 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, the reaction was subjected to preservation and dehydration for 1.5 h after the temperature was 130° C. After dehydration was ended, 1250 g of epoxypropane was added, wherein the reaction temperature was controlled to 140-170° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product for a low-modulus sealant was obtained by cooling and discharging after the vacuum degree reached ≥−0.098 MPa and was maintained for 30 min.

Product indexes: the molecular weight measured by gel chromatography is 29215, and a hydroxyl value of a sample tested by a chemical method is 10.1.

### Comparative Example 4

100 g of sorbitol polyoxypropylene ether with a molecular weight of 2500 and 0.13 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, the reaction was subjected to preservation and dehydration for 1.5 h after the temperature was 130° C. After dehydration was ended, 1250 g of epoxypropane was added, wherein the reaction temperature was controlled to 140-170° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product was obtained by cooling and discharging after the vacuum degree reached ≥−0.098 MPa and was maintained for 30 min.

Product indexes: the molecular weight measured by gel chromatography is 29015, and a hydroxyl value of a sample tested by a chemical method is 11.6.

### Example 5

144 g of sucrose alcohol polyoxypropylene ether with a molecular weight of 4000, 41 g of linear chain C12 alcohol polyoxypropylene ether with a molecular weight of 3800 and 0.14 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, the reaction was subjected to preservation and dehydration for 2 h after the temperature was 130° C. After dehydration was ended, 1217 g of epoxypropane was added, wherein the reaction temperature was controlled to 140-180° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product for a low-modulus sealant was obtained by cooling and discharging after the vacuum degree reached ≥−0.098 MPa and was maintained for 30 min.

Product indexes: the molecular weight measured by gel chromatography is 28815, and a hydroxyl value of a sample tested by a chemical method is 12.0.

### Comparative Example 5

144 g of sucrose alcohol polyoxypropylene ether with a molecular weight of 4000 and 0.14 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, preservation and dehydration was performed for 1 h after the temperature was 130° C. After dehydration was ended, 918 g of epoxypropane was added, wherein the reaction temperature was controlled to 140-180° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product was obtained by cooling and discharging after the vacuum degree reached ≥−0.098 MPa and was maintained for 10 min.

Product indexes: the molecular weight measured by gel chromatography is 28756, and a hydroxyl value of a sample tested by a chemical method is 15.6.

### Example 6

110 g of glycerol polyoxypropylene ether with a molecular weight of 3000, 40 g of linear chain C6 alcohol polyoxypropylene ether with a molecular weight of 4000 and 0.10 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, the reaction was subjected to preservation and dehydration for 2 h after the temperature was 130° C. After dehydration was ended, 1135 g of epoxypropane was added, wherein the reaction temperature was controlled to 140-180° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product for a low-modulus sealant was obtained by cooling and discharging after the vacuum degree reached ≥−0.098 MPa and was maintained for 30 min.

Product indexes: the molecular weight measured by gel chromatography is 27650, and a hydroxyl value of a sample tested by a chemical method is 5.3.

### Comparative Example 6

120 g of glycerol polyoxypropylene ether with a molecular weight of 3000 and 0.10 g of dimetallic complex DMC catalyst were added into a 2.5 L high-pressure stirring reactor, the reactor was vacuumed with a vacuum pump, air in the reactor was replaced with N₂ for three times, then, heating dehydration was performed while vacuuming under a vacuum degree of ≥−0.096 MPa, the reaction was subjected to preservation and dehydration for 2 h after the temperature was 130° C. After dehydration was ended, 1000 g of epoxypropane was added, wherein the reaction temperature was controlled to 140-180° C., the pressure in the reactor was controlled to −0.05 to 0.40 MPa, preservation was performed to continue the reaction after addition was ended until the pressure dropped no longer. After the reaction was ended, degassing was performed in vacuum, and finally a finished polyether product was obtained by cooling and discharging after the vacuum degree reached ≥−0.098 MPa and was maintained for 30 min.

Product indexes: the molecular weight measured by gel chromatography is 27550, and a hydroxyl value of a sample tested by a chemical method is 6.1.

Performance Test:

Polyether samples prepared in examples 1-6 and comparative examples 1-6 were respectively used to react with 2-isocyanate ethyl triethoxysilane in the presence of a catalyst to prepare silane modified polyether. Ratios of materials were based on a fixed molar ratio of −OH to —NCO being 1:11, and other reaction conditions were the same. A reaction formula for preparing silane modified polyether from polyether is as follows (exemplified by dihydroxy polyether):

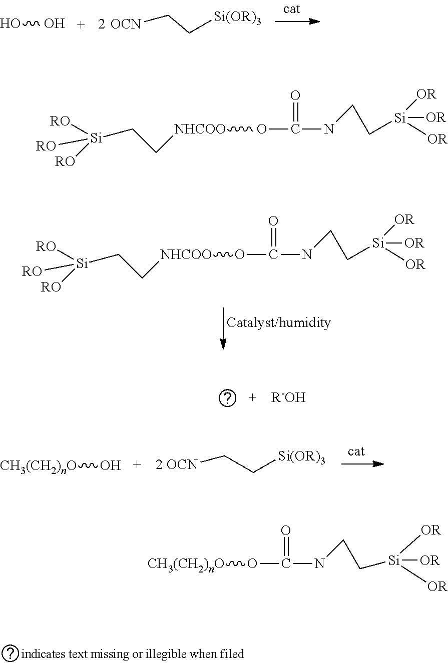

Specific steps for preparing the sealant are as follows:

(1) the sealants were prepared from the silane modified polyether prepared in each example and each comparative example based on a formulation in table below:

| Raw materials | Silane modified | Plasticizer | Dewatering | Heavy calcium | Light calcium | Coupling agent | Catalyst |
|---|---|---|---|---|---|---|---|
| | polyether | | agent | | | | |
| Name | * | Dioctyl | Vinyl | Heavy calcium | Light calcium | γ-aminopropyl | Dibutyltin |
| | | phthalate | methoxysilane | carbonate | carbonate | triethoxysilane | silicate |
| Ratio | 20.0 | 20.0 | 2.0 | 44.0 | 12.2 | 1.6 | 0.2 |

Note:
“*” represents silane modified polyether prepared from polyether in examples and comparative examples

(2) a specific preparation process of a sealant is as follows:

a. mixed production was performed using a dual-planetary stirrer: light calcium, heavy calcium, a silane modified polyether polymer, a coupling agent and a plasticizer were put into a material vat and evenly stirred;

b. a water absorbent was added and stirred at a high speed until being evenly dispersed, wherein the material has no particles;

c. the reaction was heated to 100-150° C., vacuumed and preserved for 1-3 h;

d. the reaction was cooled to 30-60° C., and then vacuuming was stopped; and

e. a catalyst was added and evenly stirred, followed by defoaming and gumming.

(3) The tensile strength, elongation at break and tensile modulus of the silane modified polyether sealants obtained in each example and each comparative example were measured.

Where, the tensile strength and the elongation at break were measured based on a test specified in GB/T528-2009-“DETERMINATION OF TENSILE STRESS-STRAIN PROPERTIES OF VULCANIZED OR THERMOPLASTIC RUBBER”, and the tensile modulus was measured based on GB/T 13477-2002 “TEST METHODS FOR BUILDING SEALING MATERIALS”. Results are seen in Table 1.

TABLE 1
Effect data of sealants synthesized by polyether
in each example and each comparative example

| | | Ratio of | | | |
|---|---|---|---|---|---|
| | | monohydric | | | |
| | Molecular | alcohol | | | |
| | weight of | ether in | | | |
| | corre- | polyether | Tensile | Elongation | Tensile |
| | sponding | starter | strength | at break | modulus |
| Effect data | polyether | (%) | (MPa) | (%) | (MPa) |
| Example 1 | 4980 | 8 | 1.96 | 605 | 0.28 |
| Comparative | 4982 | 0 | 1.98 | 554 | 0.38 |
| example 1 | | | | | |
| Example 2 | 8610 | 14.8 | 1.83 | 635 | 0.26 |
| Comparative | 8588 | 0 | 1.88 | 580 | 0.36 |
| example 2 | | | | | |
| Example 3 | 18200 | 20 | 1.71 | 662 | 0.24 |
| Comparative | 18250 | 0 | 1.79 | 593 | 0.35 |
| example 3 | | | | | |
| Example 4 | 29215 | 25.9 | 1.78 | 674 | 0.22 |
| Comparative | 29015 | 0 | 1.84 | 596 | 0.37 |
| example 4 | | | | | |
| Example 5 | 28815 | 22 | 1.85 | 661 | 0.26 |
| Comparative | 28756 | 0 | 1.95 | 589 | 0.39 |
| example 5 | | | | | |
| Example 6 | 27650 | 26.7 | 1.68 | 678 | 0.21 |
| Comparative | 27550 | 0 | 1.78 | 596 | 0.35 |
| example 6 | | | | | |

It can be seen from 6 groups of comparison data in Table 1 that compared with the sealants prepared in comparative examples 1-6, the tensile modulus of the sealants prepared in examples 1-6 is reduced by more than 20%, and their elongation at break is increased by more than 10%. Furthermore, as the proportion of the monoalcohol polyoxypropylene ether is increased, the reduction amplitude of the tensile modulus is increased, the elongation at break is correspondingly increased, but the tensile strength is little changed. Accordingly, it is proved that the polyether prepared by using a mixture of polyhydric alcohol polyoxypropylene ether and monohydric alcohol polyoxypropylene ether as the starter can not only well enhance the rigid strength of the sealant but also reduce the elasticity modulus, overcoming the problem that the existing polyether silane modified sealant is high in modulus.

The above embodiments are only preferred embodiments of the present disclosure but cannot limit the protective scope of the present disclosure. Any non-substantive changes and replacements made by those skilled in the art on the basis of the present disclosure are all included within the protective scope of the present disclosure.

1. A synthesis method of polyether for a low-modulus sealant, comprising the following steps: reacting by using a mixture of monohydric alcohol polyoxypropylene ether and polyhydric alcohol polyoxypropylene ether as a starter, using epoxypropane as a chain extender and adding a metal complex catalyst, so as to obtain the polyether for the low-modulus sealant after the reaction is ended.

2. The synthesis method of the polyether for the low-modulus sealant according to claim 1, wherein in the starter, a weight ratio of the monohydric alcohol polyoxypropylene ether to the polyhydric alcohol polyoxypropylene is (5:95)-(30:70).

3. The synthesis method of the polyether for the low-modulus sealant according to claim 1, wherein the monohydric alcohol polyoxypropylene ether is a mixture of any one or more than two of butanol polyoxypropylene ether, ethanol polyoxypropylene ether, propanol polyoxypropylene ether, C6 alcohol polyoxypropylene ether, C8 alcohol polyoxypropylene ether, C10 alcohol polyoxypropylene ether and C12 alcohol polyoxypropylene ether.

4. The synthesis method of the polyether for the low-modulus sealant according to claim 1, wherein the polyhydric alcohol polyoxypropylene is a mixture of any one or more than two of glycerol polyoxypropylene ether, ethylene glycol polyoxypropylene ether, propylene glycol polyoxypropylene ether, pentaerythritol polyoxypropylene ether, sorbitol polyoxypropylene ether and sucrose alcohol polyoxypropylene ether.

5. The synthesis method of the polyether for the low-modulus sealant according to claim 1, wherein the molecular weights of the monohydric alcohol polyoxypropylene ether and the polyhydric alcohol polyoxypropylene are both 300-4000.

6. The synthesis method of the polyether for the low-modulus sealant according to claim 1, wherein the molecular weight of the polyether for the low-modulus sealant is 4000-30000.

7. The synthesis method of the polyether for the low-modulus sealant according to claim 1, wherein the amount of the catalyst is 10-100 ppm of a total amount of the starter and the epoxypropane.

8. The synthesis method of the polyether for the low-modulus sealant according to claim 7, wherein the catalyst is a dimetallic complex DMC catalyst or a multi-metallic complex MMC catalyst, or a mixture thereof.

9. The synthesis method of the polyether for the low-modulus sealant according to claim 1, wherein the amount of the epoxypropane is 4-15 times the weight of the starter.

10. The synthesis method of the polyether for the low-modulus sealant according to claim 1, wherein a reaction temperature is 100-180° C.

11. The synthesis method of the polyether for the low-modulus sealant according to claim 2, wherein the monohydric alcohol polyoxypropylene ether is a mixture of any one or more than two of butanol polyoxypropylene ether, ethanol polyoxypropylene ether, propanol polyoxypropylene ether, C6 alcohol polyoxypropylene ether, C8 alcohol polyoxypropylene ether, C10 alcohol polyoxypropylene ether and C12 alcohol polyoxypropylene ether.

12. The synthesis method of the polyether for the low-modulus sealant according to claim 2, wherein the polyhydric alcohol polyoxypropylene is a mixture of any one or more than two of glycerol polyoxypropylene ether, ethylene glycol polyoxypropylene ether, propylene glycol polyoxypropylene ether, pentaerythritol polyoxypropylene ether, sorbitol polyoxypropylene ether and sucrose alcohol polyoxypropylene ether.

13. The synthesis method of the polyether for the low-modulus sealant according to claim 2, wherein the molecular weights of the monohydric alcohol polyoxypropylene ether and the polyhydric alcohol polyoxypropylene are both 300-4000.

14. The synthesis method of the polyether for the low-modulus sealant according to claim 2, wherein the molecular weight of the polyether for the low-modulus sealant is 4000-30000.

15. The synthesis method of the polyether for the low-modulus sealant according to claim 2, wherein the amount of the catalyst is 10-100 ppm of a total amount of the starter and the epoxypropane.

16. The synthesis method of the polyether for the low-modulus sealant according to claim 2, wherein the amount of the epoxypropane is 4-15 times the weight of the starter.

17. The synthesis method of the polyether for the low-modulus sealant according to claim 2, wherein a reaction temperature is 100-180° C.
